(19) United States
(12) Patent Application Publication
(10) Pub. No.: US 2025/0007945 A1
(43) Pub. Date: Jan. 2, 2025

(54) DISTRIBUTED AUTOMATED RESPONSE CONTROL NETWORKS AND RELATED SYSTEMS AND METHODS

(71) Applicant: Battelle Energy Alliance, LLC, Idaho Falls, ID (US)

(72) Inventor: Craig G. Rieger, Pocatello, ID (US)

(21) Appl. No.: 18/697,702

(22) PCT Filed: Oct. 14, 2022
(86) PCT No.: PCT/US2022/078111

§ 371 Date: Apr. 1, 2024

Related U.S. Application Data
(60) Provisional application No. 63/262,598, filed on Oct. 15, 2021.

(51) Int. Cl. H04L 9/40

(52) U.S. Cl. CPC H04L 63/1441; H04L 63/1416

(57) ABSTRACT

Distributed automated response control (ARC) networks and related systems and methods are disclosed. A distributed automated response controller network includes a plurality of a plurality of information technology devices and a plurality of operational technology devices. The plurality of information technology devices and the plurality of operational technology devices include a plurality of communication endpoints organized to operate in a distributed hierarchy. The distributed hierarchy includes a bottom tier and one or more higher tiers. The bottom tier includes a first portion of the plurality of communication endpoints configured to perform device controls for the plurality of operational technology devices responsive to a detected threat. The one or more higher tiers include one or more other portions of the plurality of communication endpoints. The one or more other portions of the plurality of communication endpoints are configured to perform network controls responsive to the detected threat.

### CROSS REFERENCE TO RELATED APPLICATIONS

This application is a national phase entry under 35 U.S.C. § 371 of International Patent Application PCT/US2022/078111, filed Oct. 14, 2022, designating the United States of America and published as International Patent Publication WO 2023/064898 A1 on Apr. 20, 2023, which claims the benefit under Article 8 of the Patent Cooperation Treaty to U.S. Patent Application Ser. No. 63/262,598, filed Oct. 15, 2021, the contents of both of which are hereby incorporated by reference in their entireties.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to distributed automated response control (ARC) networks, and more specifically to a distributed hierarchy including cyber-physical feedback loops to enable resiliency in detecting and reacting to threats.

### BACKGROUND

Critical Infrastructure are examples of control systems that society relies on for maintaining health and stability. These systems have been designed to cope with events like natural disasters and maintenance outages but their ever-growing reliance on network connectivity introduces concerns from evolving cyber threats. Cyber-attacks have been used to successfully disable, damage, and disrupt the function of control systems.

### BRIEF SUMMARY

In some embodiments, a distributed automated response controller network includes a plurality of information technology devices and a plurality of operational technology devices. The plurality of information technology devices and the plurality of operational technology devices include a plurality of communication endpoints organized to operate in a distributed hierarchy including a bottom tier of the distributed hierarchy, which includes a first portion of the plurality of communication endpoints. The first portion of the plurality of communication endpoints is configured to perform device controls for the plurality of operational technology devices responsive to a detected threat. The one or more higher tiers of the distributed hierarchy include one or more other portions of the plurality of communication endpoints. The one or more other portions of the plurality of communication endpoints are configured to perform network controls responsive to the detected threat.

In some embodiments, a method of operating an automated response controller network includes performing, with a first portion of a plurality of communication endpoints including a plurality of information technology devices and a plurality of operational technology devices, device control for the plurality of operational technology devices responsive to a detected threat. The first portion of the plurality of communication endpoints operate as a bottom tier of a distributed hierarchy of the plurality of communication endpoints. The method also includes performing, with one or more other portions of the plurality of communication endpoints, network control of the automated response controller network responsive to the detected threat. The one or more other portions of the plurality of communication endpoints operate as one or more higher tiers of the distributed hierarchy.

In some embodiments, a power control system includes a plurality of operational technology devices and a plurality of information technology devices. The plurality of operational technology devices include power generation devices, substation devices, and loads. The plurality of information technology devices and the plurality of operational technology devices includes a plurality of communication endpoints organized to operate in a distributed hierarchy including a distributed defense tier, an intermediate defense tier, and a centralized orchestration tier. The distributed defense tier includes a first portion of the plurality of communication endpoints. The first portion of the plurality of communication endpoints is configured to perform device controls for the plurality of operational technology devices responsive to a detected threat. The intermediate defense tier includes a second portion of the plurality of communication endpoints. The centralized orchestration tier includes a third portion of the plurality of communication endpoints. The intermediate defense tier and the centralized orchestration tier are configured to perform network controls responsive to the detected threat.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a disturbance and impact resilience evaluation curve, according to some embodiments;

FIG. 2 is a block diagram of hierarchical multi-agent dynamic system (HMADS) layers, according to some embodiments;

FIG. 3 is a an example of a distributed automated response controller network, according to some embodiments;

FIG. 4 is a block diagram of a distributed automated response controller network, which is an example of the distributed automated response controller network of FIG. 3;

FIG. 5 is a block diagram of a cyber-physical feedback loop, according to some embodiments;

FIG. 6 is a block diagram of another cyber-physical feedback loop, according to some embodiments;

FIG. 7 is a block diagram of a power control system, according to some embodiments;

FIG. 8 is a flowchart illustrating a method of operating an automated response controller network, according to some embodiments; and

FIG. 9 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “resilience” refers to operation of a system at or above a threshold minimum level of normalcy despite occurrence (e.g., normal occurrence) of disturbances or adversarial activity. This threshold minimum level of normalcy may also be referred to herein as the “resilience threshold.” To achieve resilience, phases of response should be strategically planned and outlined. Holistic performance of a system maintains a recognition and response level that is above the resilience threshold.

Conventional information technology (IT) security devices such as firewalls and intrusion detection systems (IDSs) have proven to be insufficient against advanced threats. Attacks are becoming increasingly automated to the point where human response may not mitigate a cyber-threat. An attack exploiting even a single vulnerability of an operational technology (OT) system may severely damage the OT system. New techniques such as automated response may be used to fill in the gaps of protection left by traditional IT security measures in order to combat modern cyber-threats.

Conventional solutions are not active (e.g., are passive), and even where orchestration is applied, a human is required to evaluate evidence of cyber-attacks and respond to identified cyber-attacks, which creates delays in response. Delays may enable cyber-attacks to continue to propagate before the cyber-attacks are responded to. Some challenges to applying autonomous cyber resilience solutions to control systems lie in the fidelity of correlating malicious versus benign change, context on the type of cyber-attack, and responses that only mitigate the attack without causing additional impact to the physical system where the attack originated.

According to various embodiments disclosed herein, the ability to recognize and surgically (e.g., precisely) respond to cyber-attacks to control systems such that a high level of mitigation may be achieved while reducing the impact to operations is relevant to achieving cyber resilience. The two pieces of the Cyber-physical Resilience through Automated Response and Recovery (CyRARR) design include recognition and response. Recognition includes more than the awareness that the attack is cyber related. Recognition also includes identification of what type of attack is being launched. These can take various forms, including denial of service and data injection. Through the process of identification, which is facilitated by analysis of both cyber and physical data to provide context, a regimen of cyber and physical mitigations may be selected by a process of benefit versus physical impact. Surgical responses to identified attacks may include changes in network behaviors such as routing and protocol allowance, account privileges modifications or account isolation, host application process isolation, other changes in network behaviors, or combinations thereof.

By utilizing an intelligent cyber-sensor capable of processing cyber and physical data, machine learning may be used in conjunction with situational awareness to surgically identify anomalous activity, the type of cyber-attack being launched, and the physical system affected. An automated response engine may be used to monitor health of a system given set standard operational levels, and execute tactical actions to mitigate and prevent malicious and/or erroneous behavior within the operating environment. By way of non-limiting examples, these tactical actions may include isolation of communications or protocols, automatic restriction of permissions to an affected role/user, and/or blocking access to the system all together. Also by way of non-limiting example, these tactical actions may also include restorative physical (as compared to just cyber) actions by the control system to use a diverse, isolated backup or to correct maligned settings or information directly. By leveraging automated response, the system may be equipped to actively handle these responses in the network to improve the speed of mitigation while maintaining system integrity.

The ability to modify user roles when anomalous activity is present (e.g., using an intelligent sensor to detect abnormal activity) may enable a system to actively and automatically tighten permissions to affected roles or users, which may protect the systems from changes to the system that could cause harm. In the event an attacker has gained access to a device in the network and attempts to inflict harm through the modification network and attempts to inflict harm through the modification or alteration of the device, discrepancies in the system may be detected and mitigations may be made. Specifically, the affected device may be isolated from making harmful changes while switching to and using a trusted, isolated device that has comparable operational capabilities (but may use a diverse technology not vulnerable to the same attack type). Actions may be taken to regain control of the affected device while the rest of the system remains protected and operational.

Through the development of a Cyber-physical Resilience through Automated Response and Recovery (CyRARR) system, the resilience of critical infrastructure may be increased. For example, a layer of protection may be added to sensitive control system environments by dynamically and automatically providing mitigation against attacks without human intervention. Analysis of this approach has been conducted on a physical distributed microgrid emulation, providing meaningful impact and performance metrics.

Systems according to embodiments disclosed herein may reduce a time scale of response to cyber-attacks, which may reduce impacts from the cyber-attacks. Implemented mitigations may stop the cyber-attacks and enable remedial actions to advance more rapidly responsive to cyber-attacks, which may improve speed of recovery from damage caused by cyber-attacks. Reduction in the time scale of response may reduce or even prevent impacts from a cyber-attack and allow for remedial actions to advance more rapidly if an attack has occurred. In addition, the ability to be surgical in recognition and response may increase system recognition and mitigation response while minimizing collateral impacts to operation.

Similar to a multi-agent hierarchy for a resilient control system design, an HMADS cyber recognition and response architecture may contribute to system resilience. A hierarchical framework based, at least in part, on a three-layer multi-agent system with recognition and response capabilities for cyber events is disclosed. This hierarchical framework benefits from the tiers of recognition and response and collection of distributed data sets to improve confidence in recognition due to the increased data richness. The benefits of the distributed framework over a centralized framework may be realized. Each level of hierarchy includes cyber “sensors” and “actuators” providing a traditional control system like attenuation of error signal due to cyber-attacks.

Cyber resilient control systems according to embodiments disclosed herein proactively recognize and respond to uncertain threats. These threats may be from cyber or physical origins, including benign sources and malicious human sources. Similar to a multi-agent hierarchy for a resilient control system design, an HMADS cyber recognition and response architecture may contribute to system resilience. A hierarchical framework based, at least in part, on a three-layer multi-agent system with recognition and response capabilities for cyber events is disclosed. This hierarchical framework benefits from the tiers of recognition and response and collection of distributed data sets to improve confidence in recognition due to the increased data richness. The benefits of the distributed framework over a centralized framework may be realized. Each level of hierarchy includes cyber “sensors” and “actuators” providing a traditional control system like attenuation of error signal due to cyber-attacks.

Disclosed herein is the basis for a tiered cyber resilience HMADS. The disclosed framework considers both the cyber and physical interactions to provide detailed reporting and response to cyber-attacks considering the possible sensing, decision schemes and actions that are available to mitigate the physical impact of the attack. Alternative methods of incident response, such as moving target defense, tend to just focus on providing deception to attack. Nevertheless, the HMADS framework may enable discovery of a set of custom-tailored responses to cyber disturbances much like a physical feedback control system. Various tools (e.g., commercial-off-the-shelf (COTS) tools), even for the ICS environment, may provide a benefit in recognizing cyber-attacks. However, research to develop endpoint analysis, appropriate responses and the tradeoff space between the consequence (and benefit) of a cyber mitigation to the physical space may enable the future of agile cyber resilience in the ICS environment.

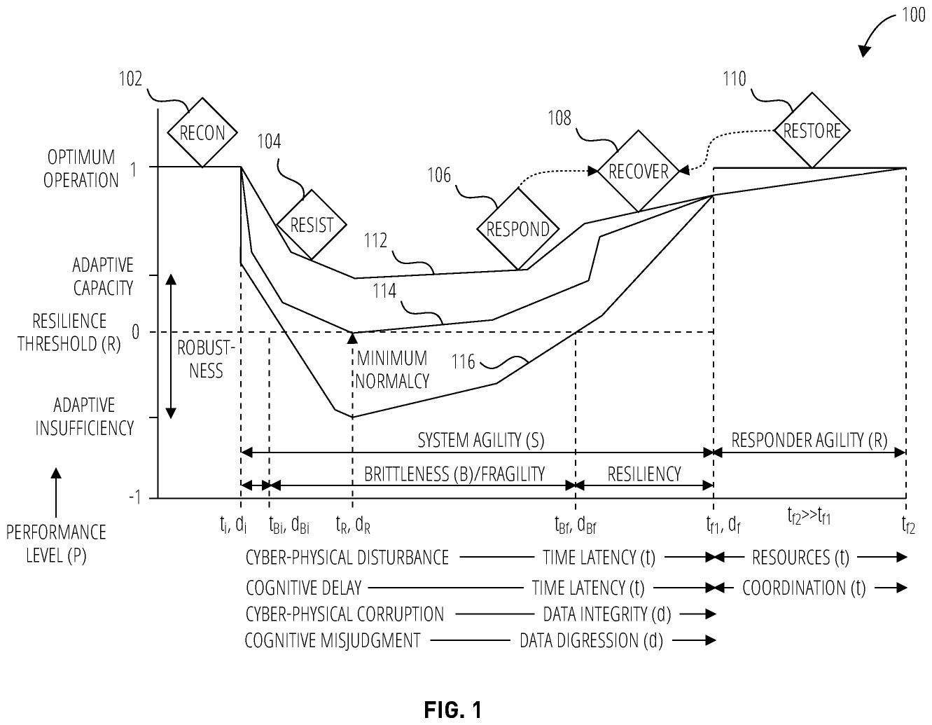

FIG. 1 is a disturbance and impact resilience evaluation curve 100, according to some embodiments. Five factors, known as “the five ‘R’s of Resilience,” may influence a resilience threshold of a system. These five factors, or equivalently “phases of disturbance,” are recon 102, resist 104, respond 106, recover 108, and restore 110. Recon 102 may include maintaining proactive state awareness of system conditions and degradation. Resist 104 may include system response to recognized conditions, both to mitigate and counter. Respond 106 may include stopping system degradation and returning system performance to normal operation. Restore 110 may include longer term performance restoration (e.g., equipment replacement). Recover 108 may include considering additive respond and restore actions.

A performance level (PERFORMANCE LEVEL (P)) of two resilient system curves 112, 114 and an un-resilient system curve 116 are shown in the disturbance and impact resilience evaluation curve 100. The performance level (PERFORMANCE LEVEL (P)) is shown on a scale from −1 to 1, where 1 is an optimum operation. An adaptive insufficiency threshold between −1 and 0 on the performance level scale is shown in FIG. 1. The adaptive insufficiency is the lowest point on the un-resilient system curve 116. An adaptive capacity threshold between 0 and 1 on the performance level scale is also shown in FIG. 1. The adaptive capacity is a lowest point of the resilient system curve 112. A resilience threshold (RESILIENCE THRESHOLD (R)) is shown at substantially zero on the performance level. The resilience threshold is a lowest point of the resilient system curve 114. A robustness of the resilient system curves 112, 114 and the un-resilient system curve 116 is measured between the adaptive capacity and the adaptive insufficiency. Accordingly, the robustness is a range of the performance level from the lowest point of the un-resilient system curve 116 and the lowest point of the resilient system curve 112.

A time scale of the disturbance and impact resilience evaluation curve 100 includes various point indicators including tᵢ, dᵢ; t_{Bi}, d_{Bi}; t_{R}, d_{R}; t_{Bf}, d_{Bf}; t_{f1}, d_{f}; and t_{f2}, each of which is marked in FIG. 1 with vertical broken lines. During the recon 102, the resilient system curves 112, 114 and the un-resilient system curve 116 show substantially optimum operation (performance level (P) is substantially 1). During resist 104, the resilient system curves 112, 114 and the un-resilient system curve 116 decrease from tᵢ, dᵢ to t_{Bi}, d_{Bi} then to t_{R}, d_{R}, as shown in FIG. 1. At t_{R}, d_{R} the resilient system curve 112 is at the adaptive capacity, the resilient system curve 114 is at the resilience threshold, and the un-resilient system curve 116 is at the adaptive insufficiency. At t_{R}, d_{R} the resilient system curves 112, 114 and the un-resilient system curve 116 start to increase through t_{Bf}, d_{Bf} and to t_{f1}, d_{f}. At t_{f1}, d_{f} the resilient system curves 112, 114 and the un-resilient system curve 116 are substantially the same. System agility (SYSTEM AGILITY(S)) is illustrated between tᵢ, dᵢ and t_{f1}, d_{f}. During the system agility period, a cyber-physical disturbance may progress to a time latency (t), a cognitive delay may progress to a time latency (t), a cyber-physical corruption may progress to data integrity (d), and/or cognitive misjudgment may progress to data digression (d). Brittleness/fragility (BRITTLENESS (B)/FRAGILITY) is illustrated between t_{Bi}, d_{Bi} and t_{Bf}, d_{Bf}. The respond 106 factor is illustrated between t_{R}, d_{R} and t_{Bf}, d_{Bf}. Resiliency, accompanying the recover 108 factor, is illustrated from t_{Bf}, d_{Bf} to t_{f1}, d_{f}. Finally, responder agility (RESPONDER AGILITY (R)) is illustrated from t_{f1}, d_{f} to t_{f2}, which corresponds to the restore 110 factor, and during which the resilient system curves 112, 114 and the un-resilient system curve 116 increase to optimum operation (substantially a 1 on the performance level (p)). The time t_{f2} is much later than t_{f1} (t_{f2}>>t_{f1}). During responder agility, resources (t) and coordination (t) are shown in FIG. 1.

Cyber security defense mechanisms according to various embodiments disclosed herein may not merely base their recognition operation in IDSs. Considering resilience in the context of control system security, however, points to a need for a regulatory design, not unlike the basic requirement of control theory engineering. By way of non-limiting example, within the physical operations of a fluid flow system, a tank level is maintained by modulating an actuator moving a position of an outlet valve based on a comparison of a level sensor to a setpoint and gains of proportional-integral-derivative (PID) control law to reduce a level offset error. Similarly, cyber resilience according to various embodiments disclosed herein may include an analogous ability to sense, make a decision, and take action. This process may include evaluating anomalies that are indicative of malicious activity and/or deviations from expected normal behavior (e.g., detected with cyber sensors) and inducing specific system changes through cyber actuators to mitigate the threats (e.g., by applying cyber control laws). In this context, a non-limiting example of a sensor may be a network traffic analyzer, while an example of an actuator may be a firewall. Although confidence in these and other mechanisms may not be absolute, a tradeoff space analysis may be used to identify an appropriate (e.g., even if not optimal) response.

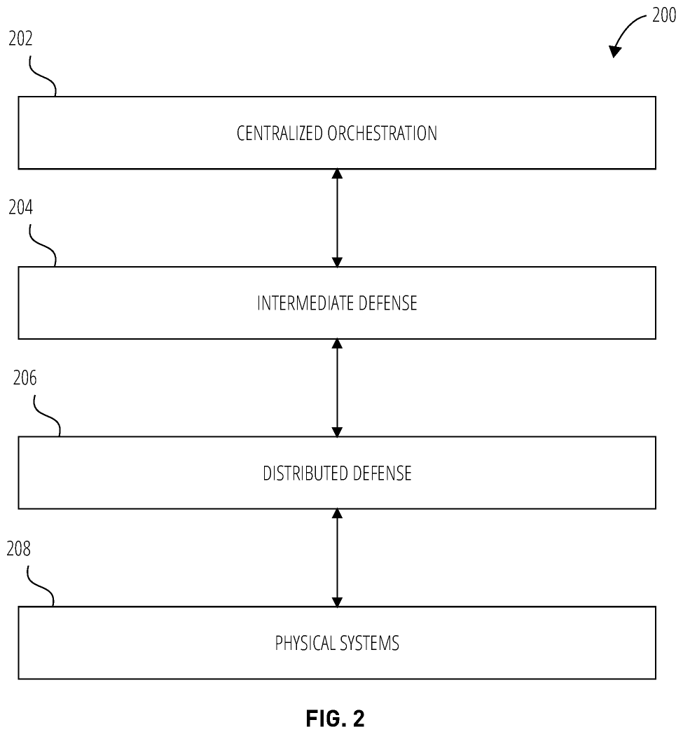

FIG. 2 is a block diagram of HMADS layers 200, according to some embodiments. The HMADS layers 200 include a centralized orchestration layer 202, intermediate defense layer 204, and distributed defense layer 206, which may interact with physical systems 208. The physical systems 208 may include physical equipment of a system, and the centralized orchestration layer 202, the intermediate defense layer 204, and the distributed defense layer 206 may include tiers of cyber security. Various embodiments disclosed herein relate to the applicability of a tiered, dynamical framework (e.g., the HMADS layers 200, without limitation) for cyber resilience in control systems, and the fundamental elements of a multi-agent design. The disclosed approach provides a basis for active feedback and reaction capabilities to achieve a state awareness and response reflective of resilience. Each level (e.g., layer) may include different types of cyber sensors, actuators, and controllers.

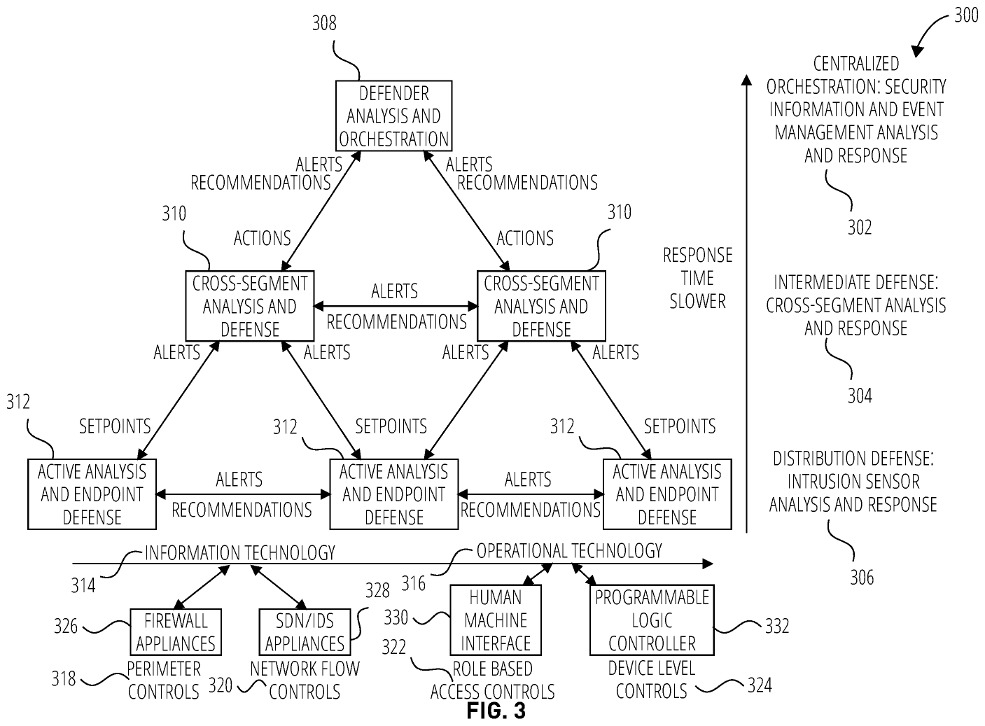

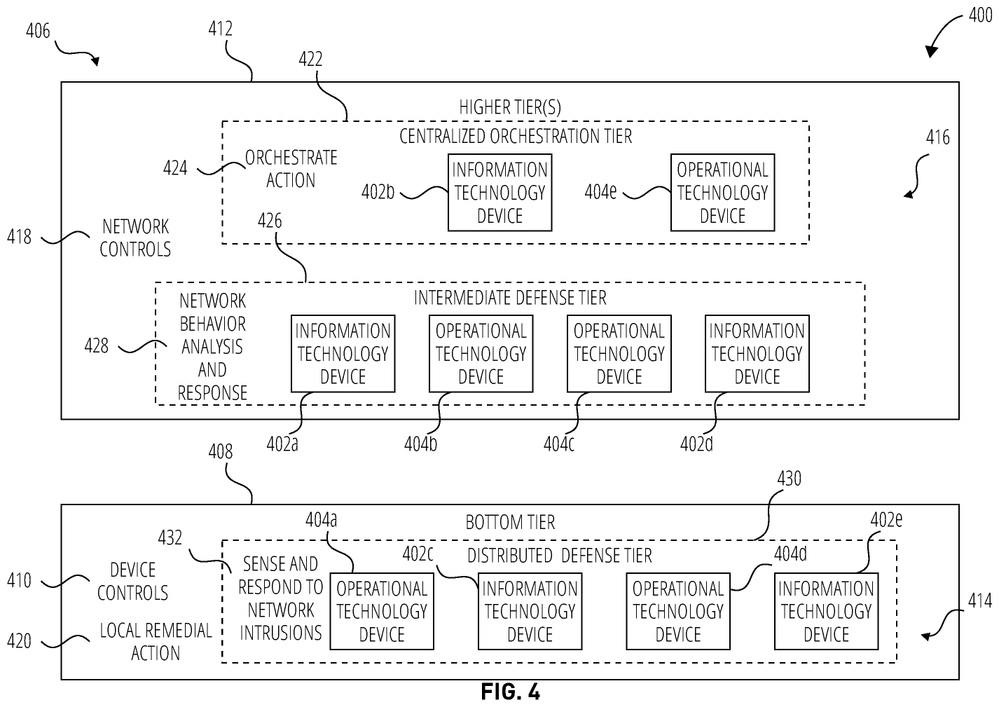

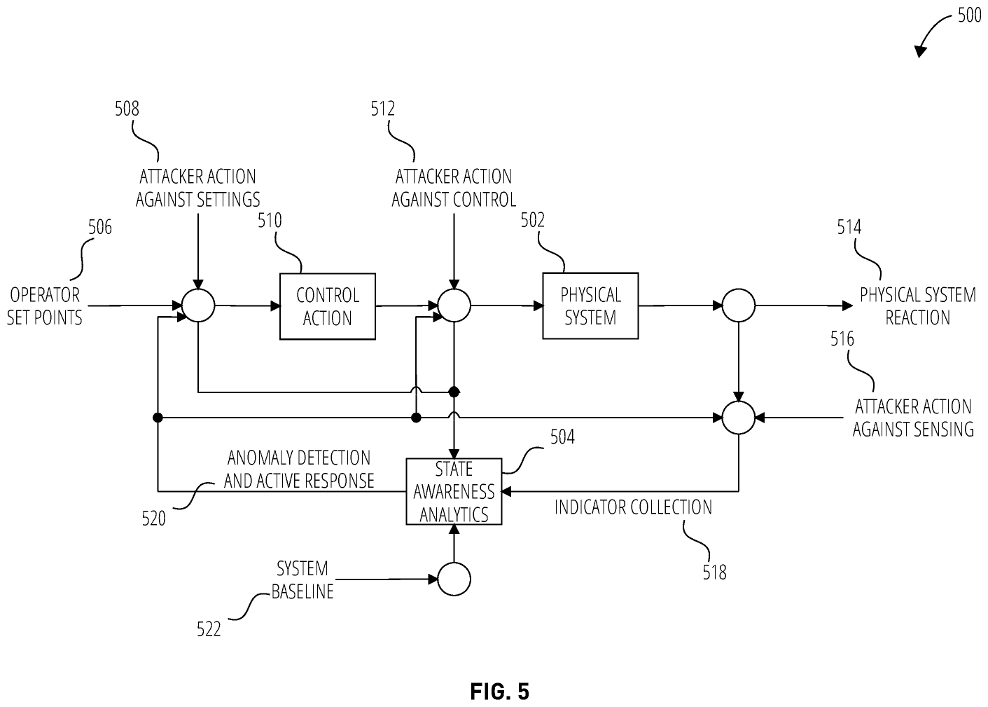

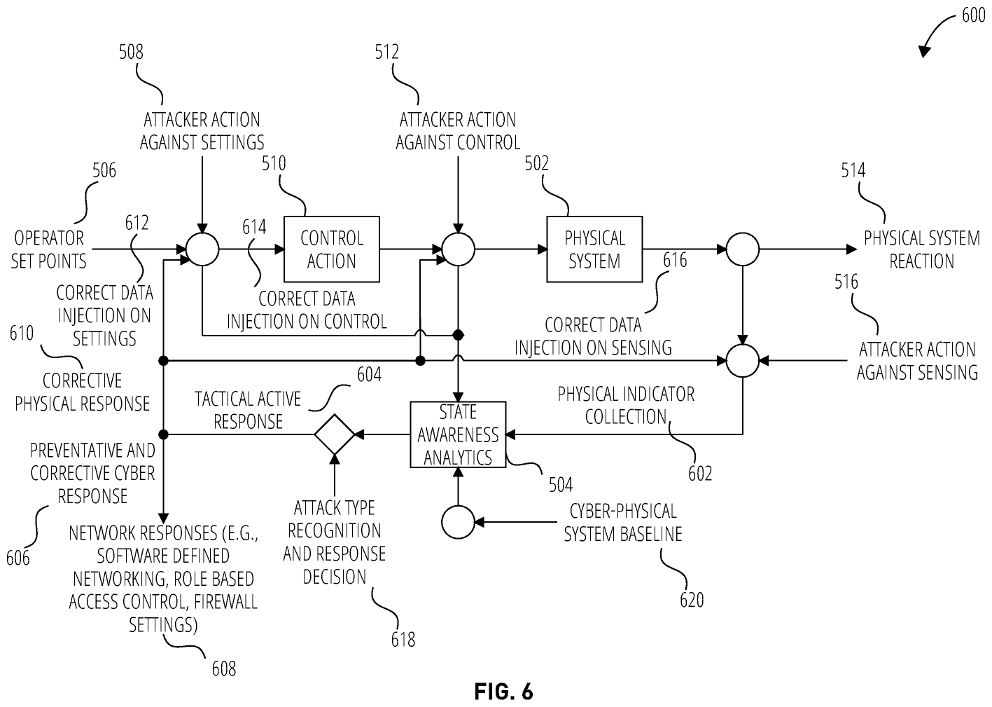

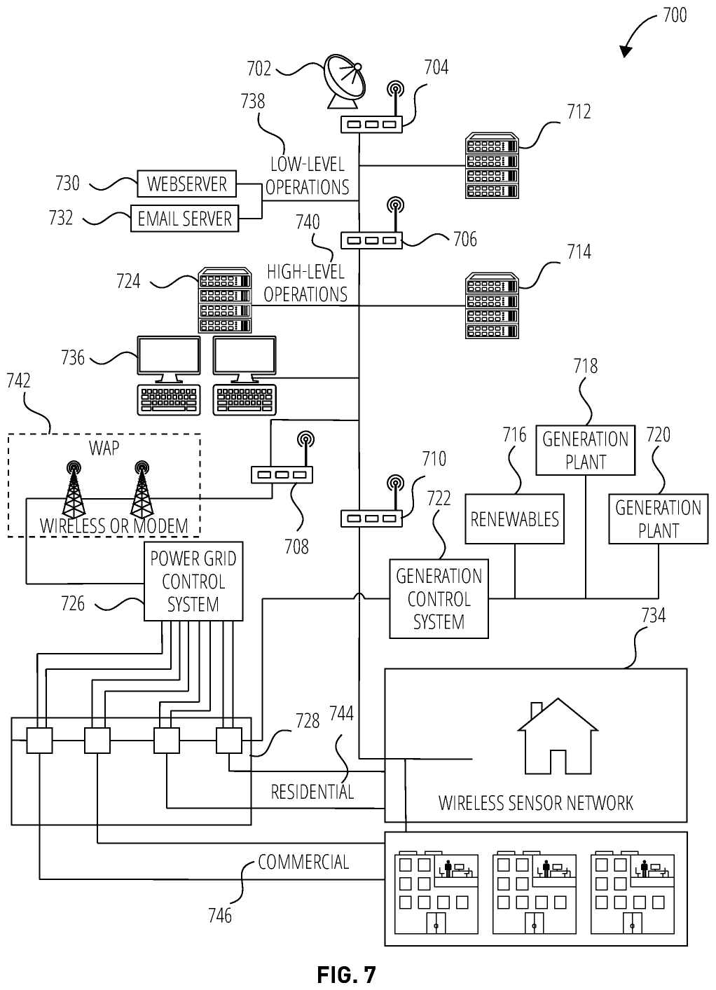

Various embodiments disclosed herein may provide a perspective on a strategy for dynamic, hierarchical cyber control based, at least in part, upon control theory. With reference to FIG. 2, FIG. 3, and FIG. 4, tiers of the dynamic, hierarchical framework are discussed herein. With reference to FIG. 5 and FIG. 6, a general discussion of cyber-physical feedback loops at different tiers is provided. With reference to FIG. 7, a use case that may populate the tiers in the form of agents is discussed.

An HMADS framework provides the benefits of a tier-centric response architecture. Alternative multi-tiered and multi-agent approaches for resilient control systems may be used. These systems are tailored for future distributed system design. Within the HMADS, the lowest layer of response (e.g., the distributed defense layer 206) includes time-based dynamics and integrates elements of control theory. The higher layers (e.g., intermediate defense layer 204 and centralized orchestration layer 202) are event-based and include management and coordination to establish operational goals as well as the realignment of system operation to achieve these goals. In control engineering, this may be characterized as a hybrid system.

When considering possible extensions to incorporate cybersecurity, a cyber-resilient version of the HMADS may, by design, include both time and event-based responses at each tier (e.g., at each of the centralized orchestration layer 202, the intermediate defense layer 204, and the distributed defense layer 206). While a different number of layers can be used, various examples disclosed herein use three layers (e.g., centralized orchestration layer 202, intermediate defense layer 204, and distributed defense layer 206) that are suitable to identify distinct and separate functionality.

The centralized orchestration layer 202 performs overall orchestration actions and defines priorities regarding cyber defense mechanisms deployed across rich communication services (RCS). The centralized orchestration layer 202 may have access to data about the entire system, which may include both cyber and physical data sets. The sensor may be virtual in marshalling the full data set appropriately to arrive at a holistic analysis of past performance and predictions of future performance as the cyber controller. The actuator may perform the conveyance of confidence in the anomaly detection to lower layers (e.g., intermediate defense layer 204 and distributed defense layer 206) to inform detection and responses.

The intermediate defense layer 204 tier provides network behavioral analysis as well as corresponding response based, at least in part, on the orchestration dictated by a higher layer (e.g., the centralized orchestration layer 202, without limitation). To meet these goals, a set of sensors that are elements of an IDS is connected directly on the system. The intermediate defense layer 204 level may be viewed as an anomaly detection baselining of node configuration, performance parameters, logs, etc. This operation may occur at the network-segment level, so actuators may include a software defined network (SDN) and isolation of protocols, ports and sources. The control law may be based, at least in part, on the interpretation of the criticality and expected impact of the anomaly on the physical system.

The distributed defense layer 206 is the lowest layer tier of the HMADS layers 200 of FIG. 2. The distributed defense layer 206 tier provides direct monitoring of the IDS and is in charge of remedial actions and agile response toward stopping and/or mitigating a malicious event. Actuators may include malicious component isolation, the application of diverse redundancy of control devices or physical control functions, or combinations thereof. The control system may be architected to enable minimal control even in the absence of interaction with the higher levels (the centralized orchestration layer 202 and the intermediate defense layer 204) of the system. This may allow for the isolation actions of the intermediate defense layer 204 layer to be performed without impacting system stability.

FIG. 3 is a block diagram of an example of a distributed automated response controller network 300, according to some embodiments. In considering the HMADS layers 200 of FIG. 2, one example of a more detailed implementation is presented in FIG. 3, which illustrates details of an orchestrated cyber response. For example, the distributed automated response controller network 300 includes centralized orchestration 302 (security information and event management analysis and response), intermediate defense 304 (cross-segment analysis and response), and distributed defense 306 (intrusion sensor analysis and response), which are similar to the centralized orchestration layer 202, intermediate defense layer 204, and distributed defense layer 206 discussed above with reference to FIG. 2. The centralized orchestration 302 may include defender analytics and orchestration 308. The intermediate defense 304 may include cross-segment analysis and defense 310. The distributed defense 306 may include active analysis and endpoint defense 312. Unlike a physical-only regulatory system, a cyber-resilient response consumes and analyzes both physical and cyber data. Moreover, the response extends in these two regimes (the physical regime and the cyber regime). Access to both the cyber and physical data is assumed by all three layers.

Alerts and/or recommendations may be communicated between nodes (cross-segment analysis and defense 310 nodes) of the intermediate defense 304 layer, and between nodes (active analysis and endpoint defense 312 nodes) of the distributed defense 306 layer. Alerts and/or recommendations as well as actions may be communicated between the node (defender analytics and orchestration 308 node) of the centralized orchestration 302 layer and the nodes (cross-segment analysis and defense 310 nodes) of the intermediate defense 304 layer. Set points and alerts may be communicated between the nodes (cross-segment analysis and defense 310 nodes) of the intermediate defense 304 layer and the nodes (active analysis and endpoint defense 312 nodes) of the distributed defense 306 layer.

Three tiers of analytical design are given (centralized orchestration 302, intermediate defense 304, and distributed defense 306), each of which provides a higher level of certainty of the predictions but on the downside a slower response (e.g., the centralized orchestration 302 provides the highest level of certainty but the slowest response, the distributed defense 306 provides the lowest level certainty but the fastest response). In a security information and event management (SIEM) tool, the orchestrator is a component at the top centralized orchestration 302, SDN may operate at the middle layer (intermediate defense 304) with a separate controller, and finally distributed IDS are placed at the bottom layer (distributed defense 306). The center cross-segment analysis and defense 310 provides a compromise on time vs data regarding the evaluation of any perceived abnormal occurrences across the network. With this information, responses at the local level may be engaged for the fastest response, including device controls or shutting off accounts, but longitudinal orchestration may happen at the top layer (centralized orchestration 302).

The centralized orchestration 302 layer, the intermediate defense 304 layer, and the distributed defense 306 layer may be distributed across information technology 314 and operational technology 316. The information technology 314 may include firewall appliances 326 configured to execute perimeter controls 318 and SDN/IDS appliances 328 configured to execute network flow controls 320. The operational technology 316 may include a human machine interface 330 configured to execute role based access controls 322 and a programmable logic controller 332 configured to execute device level controls 324.

In contrast to COTS tools, which may focus on network and host-based sensors, analytics, visualization, and orchestrator, some embodiments disclosed herein consider a tradeoff space between cyber mitigation benefit and resulting loss of function assessment. For example, some embodiments disclosed herein may judiciously isolate traffic or a port to prevent instability in a feedback loop, which may create worse consequences than the initial impact of the cyber-attack. Moreover, the proprietary devices, which typically include the ICS domain, prevent the use of standard agents that flawlessly work with commodity operating systems, like Linux. Also, in contrast to the majority of intrusion detection approaches and tools developed for cyber-defense, some embodiments disclosed herein may not primarily operate at the packet level of the network traffic, and are therefore able to consider the complex roles of actors operating within complex control systems. Finally, in contrast to COTS automated incident response tools that seek generic and targeted approaches, some embodiments disclosed herein may be less limited or generic.

FIG. 4 is a block diagram of a distributed automated response controller network 400, which is an example of the distributed automated response controller network 300 of FIG. 3. The distributed automated response controller network 400 includes a plurality of information technology devices 402a-402e and a plurality of operational technology devices 404a-404e. The plurality of information technology devices 402a and the plurality of operational technology devices 404a-404e include a plurality of communication endpoints 406 organized to operate in a distributed hierarchy. The distributed hierarchy includes a bottom tier 408 (e.g., the distributed defense layer 206 of FIG. 2, the distributed defense 306 of FIG. 3) and one or more higher tiers 412. The bottom tier 408 of the distributed hierarchy includes a first portion 414 of the plurality of communication endpoints 406. The first portion 414 of the plurality of communication endpoints 406 is configured to perform device controls 410 for the plurality of operational technology devices 404a responsive to a detected threat. By way of non-limiting example, the device controls 410 may include isolation of access controls, services, and device indicators of attack. In some embodiments, the bottom tier 408 of the distributed hierarchy includes a distributed defense tier 430 configured to sense network intrusions and respond to the network intrusions 432.

The one or more higher tiers 412 of the distributed hierarchy include one or more other portions 416 of the plurality of communication endpoints 406. The one or more other portions 416 of the plurality of communication endpoints 406 are configured to perform network controls 418 responsive to the detected threat. By way of non-limiting example, the network controls 418 may include application of perimeter protection and traffic controls.

Each of the communication endpoints 406 may communicate with at least one other of the communication endpoints 406. In some embodiments, the first portion 414 of the plurality of communication endpoints 406 is configured to continue to perform the device controls 410 for the plurality of operational technology devices 404a responsive to last instructions received from the one or more other portions 416 of the plurality of communication endpoints 406 of the one or more higher tiers 412 even if operation of the one or more other portions 416 of the communication endpoints 406 is interrupted.

In some embodiments, the first portion 414 of the plurality of communication endpoints 406 of the bottom tier 408 of the distributed hierarchy is configured to perform local remedial action 420 responsive to a determination that a communication endpoint of the plurality of communication endpoints 406 is compromised. By way of non-limiting example, the local remedial action 420 may include one or more of isolating compromised equipment and replacing operation of the compromised equipment with operation of redundant equipment.

In some embodiments, the one or more higher tiers 412 include a centralized orchestration tier 422 configured to orchestrate action 424 of the distributed automated response controller network 400. In some embodiments, the plurality of communication endpoints 406 is configured to establish a new centralized orchestration tier responsive to loss of operation of the centralized orchestration tier 422. In some embodiments, the one or more higher tiers 412 include an intermediate defense tier 426 configured to perform network behavior analysis and response 428.

In some embodiments, the plurality of communication endpoints 406 is configured to detect anomalous behavior responsive to observed network traffic that deviates from expected network traffic. In some embodiments, each of the bottom tier 408 and the one or more higher tiers 412 implements a cyber-physical feedback loop (see FIG. 5 and FIG. 6) considering both cyber data and physical data. By way of non-limiting example, the cyber-physical feedback loop is configured to make adjustments to operator setpoints, control action, and sensed data responsive to attacks on settings, controls, and the sensed data, respectively.

FIG. 5 is a block diagram of a cyber-physical feedback loop 500, according to some embodiments. The cyber-physical feedback loop 500 may be overlaid as a component of a physical regulator. The cyber-physical feedback loop 500 includes both cyber and physical elements. For example, the cyber-physical feedback loop 500 includes a physical system 502. The cyber-physical feedback loop 500 may be used to control operation of the physical system.

As mentioned above, recognition of degradation should evaluate both data sets (cyber and physical data sets), and responses should also mitigate in both cyber and physical areas. Anomalies from both the cyber and physical data sets are evaluated using state awareness analytics 504, and this assessment is fused for greater fidelity. To maintain operations, the physical response of a cyber-attack may include use of redundant sensors or actuators, or isolating a portion of the facility that is identified to be problematic. From the cyber side, the progression of the attack may be stopped. If the failure is only physical and non-malicious, the response may only occur to correct and maintain operation from the recognized failure.

To apply this concept within the architecture suggested in FIG. 3, subtle changes in the spheres of influence should take place between the tiers. For example, traditional orchestrated design assumes the active involvement of a centralized human-in-the-loop. However, to achieve the benefits of low latency response, delegation of responses should be defined that provide the latitude for the distributed assets to recognize and respond. Feedback loops that will be implemented at each tier include an upper layer or tier corresponding to centralized orchestration, a middle layer or tier corresponding to intermediate defense, and a lowest layer or tier corresponding to distributed defense.

The upper layer or tier corresponding to centralized orchestration may include a physical control loop, a cyber control loop, and a cyber-attacker. The physical control loop of the upper layer or tier (centralized orchestration) includes an indicator collection 518, operator set points 506, a system baseline 522 (e.g., a cyber-physical system baseline 620 of FIG. 6), and a physical system reaction 514. The indicator collection 518 includes physical information that would be used for decision support and centralized control such as a power system energy management system (EMS). The operator set points 506 include inputs from an operator that would define the performance settings, which may include automatic generation control (AGC), from the human machine interface (HMI). The system baseline includes the cyber security feature or data sets (e.g., packet information), signals at the physical layer (e.g., voltage and/or current measurements, sensory readings, etc.) for better refinement of threat. The physical system reaction 514 includes a set of responses from the physical system 502. By way of non-limiting example, a physical system reaction 514 may be power flow from an individual generator to adjust the AGC setpoints and gains based on priorities of a generator's response to frequency or voltage variation.

The cyber control loop of the upper layer or tier (centralized orchestration) may include state awareness analytics 504, and anomaly detection and active response 520. The state awareness analytics 504 include the algorithms through which anomaly detection is informed. This may be done through a combination of a hybrid of sensor data driven and first principals' models. The anomaly detection and active response 520 may involve, when anomalies are characterized, actions in the cyber and physical domains that are made to stop attack pathways and recover compromise while offsetting, if possible, data injection attacks on sensor data, setpoints, and control response, respectively. In distributed systems with multiple assets contributing to a given function, an individual asset may be disabled based on detection of behavior that is counterproductive. In a non-limiting electricity example, a generator with a compromised or faulty controller may be disconnected from the power network.

The cyber-attacker of the upper layer or tier (centralized orchestration) may include action against sensing, settings, and control. It is assumed that the attacker has the capacity of deploying data injection attacks, denial of service, other attacks, and combinations thereof, which in turn may impact data integrity and communications determinism. For a power system, this may affect overall power balance across the grid.

The middle layer or tier, corresponding to intermediate defense, may include a physical control loop, a cyber control loop, and a cyber-attacker. The physical control loop of the middle layer or tier (intermediate defense) may include an indicator collection 518, operator set points 506, system baseline 522, and a physical system reaction 514. The indicator collection 518 may include physical information that would be at a segment interface level and be part of data consumed for analysis to inform the SDN controller. The operator set points 506 include settings that would be specific to the exchange of operator setpoints from the wide area HMI to local area controls such as a generator, which crosses network segment boundaries. The system baseline includes the cyber security feature or data sets (e.g., packet information, without limitation), and potentially physical data sets, such as voltage and current, for better refinement of threat. The physical system reaction 514 includes response data from the physical system 502 that crosses network segments back to the EMS or between substations. The response data may include sensor data.

The cyber control loop of the middle layer or tier (intermediate defense) includes state awareness analytics 504 and anomaly detection and active response 520. The state awareness analytics 504 include evaluating cyber and possibly physical sensor data available within and potentially across segments. The hybrid models may inform the SDN controller on the recognized type of attack and the physical context of the effect. The anomaly detection and active response 520 may include tradeoff analysis, which may be performed to evaluate the physical operation impact and determined response. The anomaly detection and active response 520 may be performed, either through one or more humans in the loop (e.g., where critical decisions are made and high impact is assumed), through autonomous responses (e.g., when the consequences have low impact or the appropriate solution is obvious), or combinations of human and automatic performance. By way of non-limiting example, the anomaly detection and active response 520 may include an action at the network layer to block ports, reroute traffic, other action, or combinations thereof.

The cyber-attacker of the middle layer or tier (intermediate defense) includes action against sensing, settings, and control. The action against sensing, settings, and control may be performed through data injection attacks, denial of service, etc., impacting data integrity and communications determinism that cross segment boundaries or direct attack on the SDN controller or anomaly detection sources. For the power system, this could affect several segments or localized operations, such as substation to substation interactions.

The lowest layer or tier, corresponding to distributed defense, may include a physical control loop, a cyber control loop, and a cyber-attacker. The physical control loop of the lowest layer or tier (distributed defense) includes an indicator collection 518, operator set points 506, a system baseline 522, and a physical system reaction 514. The indicator collection 518 includes physical information that would be used for local decisions, and may be transferred to an EMS for centralized control. The operator set points 506 may be specific to the exchange of operator set points from the wide area HMI to local area controls such as a generator, which crosses network segment boundaries. The system baseline 522 includes the network segment specific cyber security feature or data sets, and potentially physical data sets, for better refinement of threat that would be available (e.g., such as at a substation). The physical system reaction 514 includes the response data from the physical system 502 affecting one segment, which includes substations, generators, or other control and associated devices.

The cyber control loop of the lowest layer or tier (distributed defense) includes state awareness analytics 504 and anomaly detection and active response 520. The state awareness analytics 504 includes evaluating cyber and possibly physical data available within segment. The hybrid models may inform an IDS on the threats on the appropriate response based, at least in part, on the recognized type of attack. The ability to determine that higher tier communications have been compromised at this level may enable an automated act to default to safe collection of setpoints and gains. The anomaly detection and active response 520 may include tradeoff analysis, which may be performed to evaluate the physical operation impact and determined response by a local automated response controller (ARC). The anomaly detection and active response 520 may be performed, either through one or more humans in the loop (e.g., where critical decisions may be made and impact is involved), autonomous responses (e.g., where the consequence is low or solution obvious), or a combination of human and automatic performance. A response at the network layer may be made.

The cyber-attacker of the lowest layer or tier (distributed defense) includes action against sensing, settings, and control. Malicious actions occur within one network segment and individual devices. For the power system, this may affect localized operations on the system, such as at the substation and devices like protection relays.

With the general function of the feedback loop of each tier in mind, the interactions between tiers as well as within the ones within each tier may enable a functional HMADS. Rather than implementing these tiers in a centralized fashion, the tiers may be implemented in a distributed fashion. In general, the top tiers may receive state awareness information from the lower tiers and provide recommendations, such as set points, back to the lower tiers.

By way of non-limiting example, spheres of influence as shown in Table 1 may be defined. Within these tiers, some level of raw data sharing and confirmation of trustworthiness may be instantiated. In this context, trustworthiness extends outside of the scope of just encryption but also includes comparative analysis of the data by multiple independent agents to confirm the same alert or conclusion.

TABLE 1
Spheres of Influence

| Tier | 1 | 2 | 3 |
|---|---|---|---|
| 1 | Contains overall security | Provide analytical | Provide analytical |
| | policy and tradeoff space | updates based upon | updates based upon |
| | analysis for | overall system threats | overall system threats |
| | dissemination. | and response latitude. | and response latitude. |
| 2 | Transmit cross-segment | Maintain cross-segment | Perform tradeoff space |
| | analytics and event | analysis for anomaly | analysis and latitude of |
| | response information. | detection and response. | autonomous response. |
| 3 | Transmit distributed | Transmit segment | Maintain raw cyber- |
| | health analysis. | analytics and event | physical analysis and |
| | | response information. | event response strategy |
| | | | in ARC. |

In some embodiments, analytics and response may be distributed. The distributed automated response controller network 300 of FIG. 3 may include a multi-agent cyber feedback system that has echelons of semi-autonomy, and that allows for actions to continue to occur with last instructions. This level of hierarchy, as indicated in FIG. 3, allows for individual elements to be lost, including the top-level orchestration (centralized orchestration 302 of FIG. 3), with continued ability of remaining elements (e.g., elements of the intermediate defense 304 and the distributed defense 306) to react at short time scales to cyber-attack until the orchestration function can be re-established elsewhere on the network. This is in stark contrast to centralized implementations, where information is transmitted to one, or even redundant locations, and if compromised, in part can lead to complete recognition and response to be lost. Cyber feedback may enable cyber resilience to be integrated within control system designs. In contrast, dependence upon centralized implementations for cyber resilience assumes collection at the end points that themselves could be compromised. In contrast to isolated analysis, dependence upon centralized implementations depends upon the continuity of the data to be received by a centralized analysis to provide effectiveness.

In a distributed design for a multi-agent cyber feedback system or ARC, the ARC recognition and response system are distributed, allowing for continued ability to adapt to cyber-attacks (or non-malicious threats such as damaging storms, without limitation) even if the orchestrator is lost at a top layer (e.g., centralized orchestration layer 202 of FIG. 2, centralized orchestration 302 of FIG. 3) of the HMADS layers 200 (FIG. 2). By contrast, a centralized ARC may depend on raw data being transmitted to a common location, which even if redundant, may be compromised, potentially leading to ineffectiveness.

In a distributed design for a multi-agent cyber feedback system or ARC, the benefits of the wide area understanding provided by the orchestrator may be recovered and occur anywhere on the communications network without impacting bandwidth. By contrast, it may be relatively difficult or impossible to recover a high-bandwidth centralized system in a centralized ARC to maintain the centralized ARC in different parts of the network.

In a distributed design for a multi-agent cyber feedback system or ARC, anomaly detection may be baselined on traffic, allowing for recognition of patterns that include cyber-attack end point compromises of hosts without interpreting logs. By contrast, in a centralized ARC the need to communicate raw data to a centralized location provides greater risk to potential attack, in addition to loss of continuity. Even if using an out of band network, analytics in a centralized ARC may be based upon end point logs that themselves may be corrupted.

The considerations of response may be dependent, at least in part, on network controls versus device controls. For example, the lowest tier (e.g., distributed defense layer 206 of FIG. 2 and distributed defense 306 of FIG. 3) of the hierarchy (HMADS layers 200 of FIG. 2) may emphasize device controls. As another example, the central tier (intermediate defense layer 204 of FIG. 2 and intermediate defense 304 of FIG. 3) and top tier (centralized orchestration layer 202 of FIG. 2 and centralized orchestration 302 of FIG. 3) may emphasize network controls. Device controls (e.g., emphasized by the lowest, or distributed defense, tier) may include the isolation of access controls, services, and device indicators of attack, such as side channel sensing, separate responses that isolate devices, or interfaces within devices. Network controls (e.g., emphasized by the higher, or intermediate defense and centralized orchestration, tiers) may include the application of perimeter protection and traffic controls, including application of the firewall and software defined networking to recognize and prevent the intrusion and propagation of malicious actions. The highest tier (e.g., centralized orchestration) also involves wide area awareness of threats, including external indicators as well as internal indicators, and the consumption/presentation of any updates to the lower tiers (e.g., the intermediate defense and distributed defense tiers) for improved awareness. As anomaly detection is the focus, these indicators provide signature capability of known threats, which complements the anomaly detection, increasing the confidence in the alert (true positive) and the need to initiate a response.

For malicious threats or cyber-attacks, both cyber and physical data and cyber and physical responses are considered. A collection of data is used both to recognize the threat through anomaly detection and to consider responses. For the anomaly detection, the distributed detection at the lower tiers (e.g., the intermediate defense 304 and the distributed defense 306 of FIG. 3) consumes this data to correlate what is normal and provide the physical context of what is affected. This cyber-physical data set provides richness and resulting confidence in the maliciousness of the alert, the attack type being launched and a context for what is affected, and where in the physical system 502 the response should be targeted (attack type recognition and response decision 618 of FIG. 6). The response is a combination of device and network controls that are relative to the target, source, and attack type to both prevent further attacks and recover.

Various embodiments disclosed herein may recognize the target, source, and type of attack, and respond to surgically mitigate the attack while minimizing the physical operation. This recognition and response may enable an understanding of the source and target of the attack without using game theory or risk tree analyses. Rather, this recognition and response may perform distributed, predetermined responses that correlate with the recognized target, source, and type of attack. By contrast, a centralized ARC has the weakness of minimizing complexity in understanding the goals of an attacker with a simple game theory effort, which may be simple to ensure a real time response. Also, a centralized ARC may use risk tree analysis, which may be unwieldy and may use substantial resources to perform quickly.

FIG. 6 is a block diagram of another cyber-physical feedback loop 600, according to some embodiments. An inspection of FIG. 5 and FIG. 6 reveals that operator setting may be provided (e.g., via human-machine interfaces). As illustrated in FIG. 5 and FIG. 6, attacker action may be asserted against settings (attacker action against settings 508). The hierarchical, distributed analytics (e.g., the distributed automated response controller network 300 of FIG. 3), however, may provide correct data injection on settings to correct and/or compensate for attacker action against settings 508. The hierarchical, distributed analytics may also be referred to herein as “state awareness analytics” (state awareness analytics 504), which are illustrated in FIG. 5 and FIG. 6.

The settings may be used to control action 510, as illustrated in FIG. 5 and FIG. 6. Attacker action may be asserted against control (attacker action against control 512). The distributed analytics, however, may provide correct data injection to correct and/or compensate for attacker action against control 512. Responsive to the control action 510 the physical system may react, providing a physical system reaction 514, as illustrated in FIG. 5 and FIG. 6.

Network traffic may be sensed, which may result in physical indicator collection 602. As illustrated in FIG. 5 and FIG. 6, attacker action may be asserted against sensing (attacker action against sensing 516). The distributed analytics, however, may provide correct data injection on sensing to correct and/or compensate for the attacker action against sensing 516.

The state awareness analytics 504 is configured to receive an indicator collection 518 indicating the network traffic and information from the control action 510. The state awareness analytics 504 is also configured to receive a system baseline 522 (e.g., a cyber-physical system baseline 620). Based, at least in part on the received indicator collection 518, the information from the control action 510, and the system baseline 522, the state awareness analytics 504 is configured to provide an anomaly detection and active response 520 (FIG. 5), which may include a tactical active response 604 (FIG. 6), a preventative and corrective cyber response 606, network responses 608 (e.g., software defined networking, role based access control, firewall settings), a corrective physical response 610, the correct data injection on settings 612, the correct data injection on control 614, and the correct data injection on sensing 616 (FIG. 6).

FIG. 7 is a block diagram of a power control system 700, according to some embodiments. The power control system 700 includes a satellite link 702, network isolation and routing devices 704, 706, 708, and 710, a virtual private network (VPN 712), a webserver 730, an email server 732, an engineering workstation 724, a command and control consoles 736, a data historian 714, command and control consoles 736, a wireless access protocol (WAP) 742, a data historian 714, power grid control system 726, a transmission and power distribution system 728, residential lines 744, commercial lines 746, a wireless sensor network 734, a power generation control system 722, renewables 716 (e.g., wind turbines, without limitation), and power generation plants 718, 720. Low-level operations 738 may be performed by the webserver 730, the email server 732, and the VPN 712. High-level operations 740 may be performed by the engineering workstation 724, the command and control consoles 736, and the data historian 714.

The power control system 700 includes a plurality of operational technology devices including power generation devices, substation devices, and loads. The power control system 700 also includes a plurality of information technology devices. The plurality of information technology devices and the plurality of operational technology devices includes a plurality of communication endpoints configured to perform device controls for the plurality of operational technology devices responsive to a detected threat. The distributed hierarchy also includes an intermediate defense tier of the distributed hierarchy. The intermediate defense tier includes a second portion of the plurality of communication endpoints. The distributed hierarchy further includes a centralized orchestration tier of the distributed hierarchy. The centralized orchestration tier includes a third portion of the plurality of communication endpoints. The intermediate defense tier and the centralized orchestration tier are configured to perform network controls responsive to the detected threat. In some embodiments, each of the plurality of communication endpoints is configured to continue operation even if operation of one or more other communication endpoints is lost.

The power control system 700 is one example of a use case of various embodiments disclosed herein. Considering the process system, such as the power control system 700 shown in FIG. 7, centralized control of a power grid, and the embodiments discussed above, a use case for a HMADS may be developed.

Security, specifically cyber security, is a relevant performance parameter for an HMADS system. An example of how cyber security is a relevant performance parameter for an HMADS system is provided on control system designs, where the dynamics of interchange between one agent and another are already implied. That is, execution (device) layer elements are associated with unit operations, substations, or optimally a stabilizable entity. This may be observed from FIG. 7, where a collection of separate generation, substations (generation plant 718, generation plant 720), and loads makes up an integral power control system 700. The power control system 700 defines an area of wide optimization. However, within the wide area operation, many state and input variables may exist. In a plant made up of many operations, the process of determining the stabilizable entities normally results in the minimization of the interactions between individual operations. In contrast to a chemical plant, where a minimization may be performed by looking at the input and output of an individual unit operation, the power grid depends, at least in part, on an overall system balance. A lack of distribution in the power grid means that the power flow from generators to loads remains within a specified range. If stability is not achieved, power loss and loss of factory and home operations, even safety, may be impacted.

Each substation may be assumed to exist on its own network segment to achieve appropriate decomposition and potential isolation of cyber-attack affects. As in FIG. 3, there would then be one distributed agent at the distributed defense 306 tier for each segment. Evolving Table 1 to an updated Table 2 for consideration of the use case, further detail in identifying the interactions may be defined.

TABLE 2
Spheres of Influence for Power System

| Tier | 1 | 2 | 3 |
|---|---|---|---|
| 1 | Contains overall | Provide analytical and | Provide analytical and |
| | security policy and | signature updates based | signature updates |
| | tradeoff space | upon overall system threats | based upon overall |
| | analysis as the | and level of latitude in | system threats and |
| | coordinating authority | isolating networks, ports, | level of latitude in |
| | for the generation and | and types of communication | isolating physical |
| | transmission assets. | between substations and | devices and traffic. |
| | | within/across generators. | |
| 2 | Transmit generator or | Maintain cross-segment | Perform tradeoff |
| | substation analytics, | analysis for anomaly | space analysis and |
| | event response | detection and response | latitude of |
| | information, and | within/across generators and | autonomous response |
| | threat comparisons | substations. | in generators and |
| | between substations | | substations versus |
| | and within/across | | human intervention. |
| | generators. | | |
| 3 | Transmit distributed | Transmit segment analytics | Maintain raw cyber- |
| | health analysis for | and event response to | physical analysis and |
| | generators and | inform impact and future | event response |
| | substations to allow | tradeoff analysis and cross- | strategy in ARC for |
| | overall system wide | segment threat analysis for | the substation segment |
| | threat analysis and | update in light of an | or within a generator. |
| | threat response | ongoing substation or | |
| | strategy update. | generator cyber-attack. | |

Side channel analysis at the end point level (e.g., at a programmable logic controller) brings several advantages, but may involve further development to be more comprehensive in attack recognition and also in response. Embodiments disclosed herein include automated response including the appropriate tiered sensing and analytics, which would enable an acceptable tradeoff analysis in ICS environments. The ability to address these issues may establish agile response and the overall resilience of control systems to cyber-attack. Finally, it is recognized that some type of restoration may be considered where software is compromised.

Table 3 outlines some examples of various attacks that may be asserted against a distributed automated controller network, attack taxonomies for the various attacks, possible targets, network effects, cyber responses, cyber mitigative benefits, physical effects, physical responses, and physical mitigative benefits, according to various examples.

TABLE 3
Outline of Example Attacks, Effects, and Responses

| | | | | | Cyber Mitigation | | | Physical Mitigative |
|---|---|---|---|---|---|---|---|---|
| Attack | Attack Taxonomy | Possible Target | Network Effect | Cyber Response | Benefit | Physical Effect | Physical Response | Benefit |
| Active Network | Protocol Based | Controller HMI | Increases Network | 1. Block scanning | 1. Stops scan, | None if the | None Needed | N/A |
| Scanning/ | | Servers Switches | Traffic Latency | ARP/IP/TCP session | warns attacker of | blocking doesn't | | |
| Enumeration | | Routers | | using SDN | detection | affect ICS | | |
| | | | | 2. MTD | 2. Provides attacker | communications | | |
| | | | | 3. Return false | with inaccurate | | | |
| | | | | results | results, makes | | | |
| | | | | 4. Stand up a | targeting difficult | | | |
| | | | | honeypot/honeynet | 3. Can aid in | | | |
| | | | | | detection of further | | | |
| | | | | | attacks if falsified | | | |
| | | | | | data is detected in | | | |
| | | | | | the future | | | |
| | | | | | 4. Prevents | | | |
| | | | | | additional targeting | | | |
| | | | | | of active devices, | | | |
| | | | | | aids in attribution | | | |
| Passive Network | Protocol Based | All Network | No Effect | None | None | None | None Needed | N/A |
| Scan/Enumeration | | Devices | | | | | | |
| SSH/Account | Traffic Based | HMI Controller | Prevent remote | 1. Block source IP | 1. Stops brute force | May not affect an | None, unless | N/A |
| Compromise | | Servers | management | using SDN | attack | ICS item unless the | compromised, | |
| | | Switches | of devices | 2. Deactivate | 2. Prevents attack | node compromised | and specific | |
| | | Routers | | account | on device, aids in | is an ICS device | attack response | |
| | | | | 3. MTD | attribution | through compromised | discussed below | |
| | | | | | 3. Prevents exploitation | account. Telnet like | according to affect | |
| | | | | | of that device | communications | | |
| | | | | | 4. Prevents | not normally real | | |
| | | | | | targeting of | time activity, but | | |
| | | | | | SSH/Account | more for set points. | | |
| | | | | | service | | | |
| Buffer Overflow | Protocol Based | Controller | Shutdown | 1. MTD | 1. Prevents | Would impact | Switch to a | Switch to a backup that |
| | | HMI Servers | controller | 2. Drop packets from | targeting of end device | affected ICS | isolated, | is not vulnerable to the |
| | | | or HMI | SDN using DPI | 2. Drops packets of | controller, and | preferably | same attack. If only |
| | | | Remote code | 3. Drop packets with | death before | interruption until | diverse backup | redundancy is possible, |
| | | | Execution | unknown MAC/IP at | effecting controller | this is affected. | | then a cyber block and |
| | | | | SDN | 3. Drops packets of | | | a redundant switch can |
| | | | | 4. Startup secondary | unknown senders | | | return normal conditions. |
| | | | | controller using | 4. Continues | | | |
| | | | | SDN | service after | | | |
| | | | | | standing up second | | | |
| | | | | | controller | | | |
| DNP3 Flood | Traffic Based | HMI Controller | Breaks control | Block incoming | Blocks attackers' | Mitigation should | Depending | Data flagged as |
| | | | feedback loop | packets by source | access to send | help recover the | upon packets | malicious to the |
| | | | | address using SDN | packets on network | system and not | being read by | operator and dropped |
| | | | | | | create new | HMI or | before control action. |
| | | | | | | problems. | controller and | |
| | | | | | | | affects, data | |
| | | | | | | | should be | |
| | | | | | | | flagged by | |
| | | | | | | | distributed | |
| | | | | | | | analytics. | |
| Denial of | Traffic Based | HMI Controller | Breaks control | 1. MTD | 1. Prevents | Mitigation may | Cyber response | Redundant system that |
| Service (DoS) | | Routers | feedback loop | 2. Block incoming | targeting of end | generally save the | should provide | is not impacted by DoS |
| | | Servers | Halts routing and | packets by source | devices | system but | primary | takes over to maintain |
| | | Switches | switching to | address using SDN | 2. Blocks attackers' | rerouting the traffic | response, but a | operation. |
| | | | multiple devices | 3. Redirect traffic | access to send | will cause potential | redundant | |
| | | | | to virtual network | packets on network | loss of monitoring | system in place | |
| | | | | 4. Disable system | 3. Allows attack to | or response, i.e., | could be | |
| | | | | processes if coming | continue a non- | inability to send | brought to bear. | |
| | | | | from known host | critical network | new set points or | | |
| | | | | | 4. Stops attack | controller | | |
| | | | | | from insider threat | responses out of | | |
| | | | | | or compromised device | date due to bad data. | | |
| DNP3/Modbus | Header Based | HMI Controller | Control loop is | 1. Place controller | 1. Restore the | Mitigation will | Depending | Data flagged as |
| replay attack | | | compromised; | and HMI on new | control loop | resolve potentially | upon packets | malicious to the |
| | | | old control | network segment | 2. Removes man in | instable or degrading | being read by | operator and dropped |
| | | | values resent | using SDN | the middle | operation based | HMI or | before control action. |
| | | | | 2. Detect and block | 3. Prevents attacker | upon bad data. The | controller and | |
| | | | | physical port of | from targeting | scale of the | affects, data | |
| | | | | attacker using SDN | control loop | ancillary affects | should be | |
| | | | | 3. MTD | | would depend on | flagged by | |
| | | | | | | what is blocked to | analytics. | |
| | | | | | | know good ICS devices. | | |
| DNP3/Modbus | Header Based | HMI Controller | Control loop is | 1. Place controller | 1. Restore the | Mitigation removes | Corrections in | The switch to an |
| integrity attack | | | compromised; | and HMI on new | control loop | compromised data, | the logic | isolated and preferably |
| | | | false control | network segment | 2. Removes man in | which could be | through | diverse controller or |
| | | | values resent | using SDN | the middle | acted upon, but | distributed | HMI with full or subset |
| | | | | 2. Detect and block | 3. Prevents attacker | may have ancillary | analytics | capability maintains |
| | | | | physical port of | from targeting | affects and would | recognition and | operation. |
| | | | | attacker using SDN | control loop | require an | response or | |
| | | | | 3. MTD | | assurance that any | switching to an | |
| | | | | | | controller. logic or | isolated | |
| | | | | | | HMI that uses it is | controller or | |
| | | | | | | placed in a good | HMI required. | |
| | | | | | | state. This good | | |
| | | | | | | state could still be | | |
| | | | | | | a degraded state. | | |
| XSS | Protocol Based | HMI Servers | Remotely execute | 1. Block incoming | 1. Stops individual | Would prevent | Response | A secondary, diverse |
| Scripting/ | | | unauthorized | packets by source | attacks | monitoring and | through | HMI would be a good |
| markup | | | control commands | address using SDN | 2. Makes targeting | control, and depend | switching to an | solution to maintain |
| injection | | | | 2. MTD | of web apps | on whether an OPC | isolated HMI | monitoring |
| | | | | | difficult (HMI | server has | required. | |
| | | | | | could be a web app) | redundancy, or for | | |
| | | | | | | a common exploit, | | |
| | | | | | | all were compromised. | | |

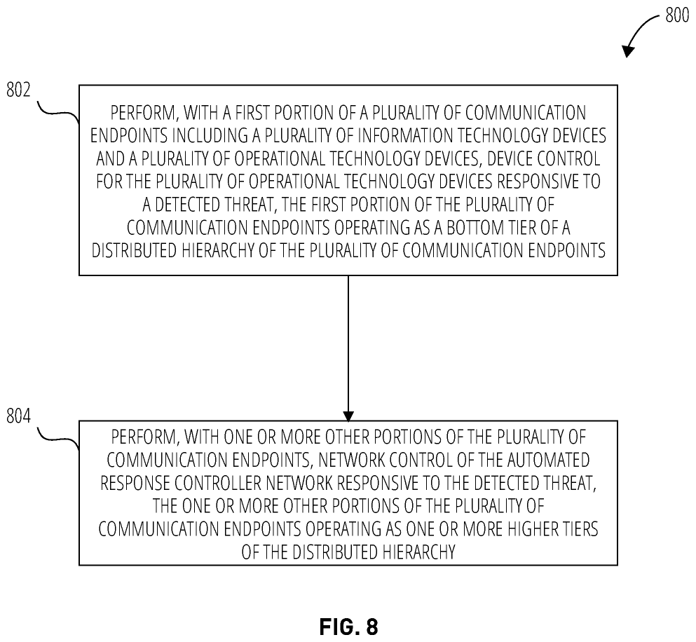

FIG. 8 is a flowchart illustrating a method 800 of operating an automated response controller network, according to some embodiments. At operation 802, the method 800 includes performing, with a first portion of a plurality of communication endpoints including a plurality of information technology devices and a plurality of operational technology devices, device control for the plurality of operational technology devices responsive to a detected threat. The first portion of the plurality of communication endpoints operating as a bottom tier of a distributed hierarchy of the plurality of communication endpoints. In some embodiments, performing the device control may include performing local remedial action responsive to a determination that a communication endpoint of the plurality of communication endpoints is compromised.

At operation 804, the method 800 includes performing, with one or more other portions of the plurality of communication endpoints, network control of the automated response controller network responsive to the detected threat. The one or more other portions of the plurality of communication endpoints operating as one or more higher tiers of the distributed hierarchy. In some embodiments, performing the network control may include applying perimeter protection and traffic controls. In some embodiments, applying the perimeter protection includes applying a firewall. In some embodiments, a threat may be detected responsive to observed network traffic that deviates from expected network traffic.

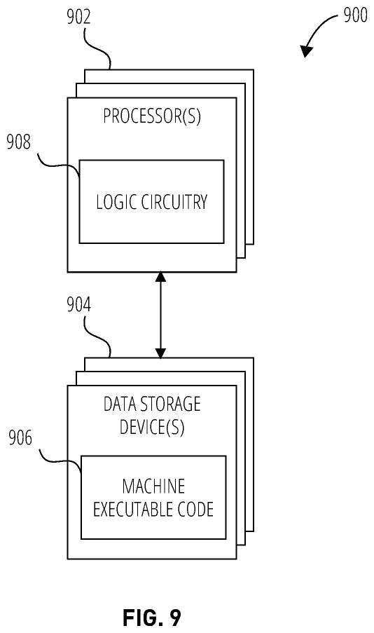

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 9 illustrates non-limiting examples of implementations of functional elements disclosed herein. In some embodiments, some or all portions of the functional elements disclosed herein may be performed by hardware specially configured for carrying out the functional elements.

FIG. 9 is a block diagram of circuitry 900 that, in some embodiments, may be used to implement various functions, operations, acts, processes, and/or methods disclosed herein. The circuitry 900 includes one or more processors 902 (sometimes referred to herein as “processors 902”) operably coupled to one or more data storage devices (sometimes referred to herein as “storage 904”). The storage 904 includes machine executable code 906 stored thereon and the processors 902 include logic circuitry 908. The machine executable code 906 includes information describing functional elements that may be implemented by (e.g., performed by) the logic circuitry 908. The logic circuitry 908 is adapted to implement (e.g., perform) the functional elements described by the machine executable code 906. The circuitry 900, when executing the functional elements described by the machine executable code 906, should be considered as special purpose hardware configured for carrying out functional elements disclosed herein. In some embodiments, the processors 902 may be configured to perform the functional elements described by the machine executable code 906 sequentially, concurrently (e.g., on one or more different hardware platforms), or in one or more parallel process streams.

When implemented by logic circuitry 908 of the processors 902, the machine executable code 906 is configured to adapt the processors 902 to perform operations of embodiments disclosed herein. For example, the machine executable code 906 may be configured to adapt the processors 902 to perform at least a portion or a totality of the method 800 of FIG. 8. As another example, the machine executable code 906 may be configured to adapt the processors 902 to perform at least a portion or a totality of the operations discussed for the defender analytics and orchestration 308 (centralized orchestration 302), the cross-segment analysis and defense 310 (intermediate defense 304), and the active analysis and endpoint defense 312 (distributed defense 306) of FIG. 3, the bottom tier 408 of FIG. 4, the one or more higher tiers of FIG. 4, the cyber-physical feedback loop 500 of FIG. 5, and/or the cyber-physical feedback loop 600 of FIG. 6.

The processors 902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 906 (e.g., software code, firmware code, hardware descriptions) related to embodiments of the present disclosure. It is noted that a general-purpose processor (may also be referred to herein as a host processor or simply a host) may be a microprocessor, but in the alternative, the processors 902 may include any conventional processor, controller, microcontroller, or state machine. The processors 902 may also be implemented as a combination of computing devices, such as a combination of a DSP and a microprocessor, a plurality of microprocessors, one or more microprocessors in conjunction with a DSP core, or any other such configuration.

In some embodiments, the storage 904 includes volatile data storage (e.g., random-access memory (RAM)), non-volatile data storage (e.g., Flash memory, a hard disc drive, a solid state drive, erasable programmable read-only memory (EPROM), etc.). In some embodiments, the processors 902 and the storage 904 may be implemented into a single device (e.g., a semiconductor device product, a system on chip (SOC), etc.). In some embodiments, the processors 902 and the storage 904 may be implemented into separate devices.

In some embodiments, the machine executable code 906 may include computer-readable instructions (e.g., software code, firmware code). By way of non-limiting example, the computer-readable instructions may be stored by the storage 904, accessed directly by the processors 902, and executed by the processors 902 using at least the logic circuitry 908. Also by way of non-limiting example, the computer-readable instructions may be stored on the storage 904, transferred to a memory device (not shown) for execution, and executed by the processors 902 using at least the logic circuitry 908. Accordingly, in some embodiments, the logic circuitry 908 includes electrically configurable logic circuitry 908.

In some embodiments, the machine executable code 906 may describe hardware (e.g., circuitry) to be implemented in the logic circuitry 908 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 908 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, the machine executable code 906 may include an HDL, an RTL, a GL description, a mask level description, other hardware description, or any combination thereof.

In embodiments where the machine executable code 906 includes a hardware description (at any level of abstraction), a system (not shown, but including the storage 904) may be configured to implement the hardware description described by the machine executable code 906. By way of non-limiting example, the processors 902 may include a programmable logic device (e.g., an FPGA or a PLC) and the logic circuitry 908 may be electrically controlled to implement circuitry corresponding to the hardware description into the logic circuitry 908. Also by way of non-limiting example, the logic circuitry 908 may include hard-wired logic manufactured by a manufacturing system (not shown, but including the storage 904) according to the hardware description of the machine executable code 906.

Regardless of whether the machine executable code 906 includes computer-readable instructions or a hardware description, the logic circuitry 908 is adapted to perform the functional elements described by the machine executable code 906 when implementing the functional elements of the machine executable code 906. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention.

1. A distributed automated response controller network, comprising:
a plurality of information technology devices; and
a plurality of operational technology devices, the plurality of information technology devices and the plurality of operational technology devices comprising a plurality of communication endpoints organized to operate in a distributed hierarchy including:
a bottom tier of the distributed hierarchy including a first portion of the plurality of communication endpoints, the first portion of the plurality of communication endpoints configured to perform device controls for the plurality of operational technology devices responsive to a detected threat; and
one or more higher tiers of the distributed hierarchy including one or more other portions of the plurality of communication endpoints, the one or more other portions of the plurality of communication endpoints configured to perform network controls responsive to the detected threat.

2. The distributed automated response controller network of claim 1, wherein the first portion of the plurality of communication endpoints is configured to continue to perform the device controls for the plurality of operational technology devices responsive to last instructions received from the one or more other portions of the plurality of communication endpoints of the one or more higher tiers even if operation of the one or more other portions of the communication endpoints is interrupted.

3. The distributed automated response controller network of claim 1, wherein the first portion of the plurality of communication endpoints of the bottom tier of the distributed hierarchy is configured to perform local remedial action responsive to a determination that a communication endpoint of the plurality of communication endpoints is compromised.

4. The distributed automated response controller network of claim 3, wherein the remedial action includes one or more of isolating compromised equipment and replacing operation of the compromised equipment with operation of redundant equipment.

5. The distributed automated response controller network of claim 1, wherein the one or more higher tiers include a centralized orchestration tier configured to orchestrate action of the distributed automated response controller network.

6. The distributed automated response controller network of claim 5, wherein the one or more higher tiers include an intermediate defense tier configured to perform network behavior analysis and response.

7. The distributed automated response controller network of claim 5, wherein the plurality of communication endpoints is configured to establish a new centralized orchestration tier responsive to loss of operation of the centralized orchestration tier.

8. The distributed automated response controller network of claim 1, wherein the plurality of communication endpoints is configured to detect anomalous behavior responsive to observed network traffic that deviates from expected network traffic.

9. The distributed automated response controller network of claim 1, wherein the device controls include isolation of access controls, services, and device indicators of attack.

10. The distributed automated response controller network of claim 1, wherein the network controls include application of perimeter protection and traffic controls.

11. The distributed automated response controller network of claim 1, wherein the bottom tier of the distributed hierarchy includes a distributed defense tier configured to sense network intrusions and respond to the network intrusions.

12. The distributed automated response controller network of claim 1, wherein each of the bottom tier and the one or more higher tiers implements a cyber-physical feedback loop considering both cyber data and physical data.

13. The distributed automated response controller network of claim 12, wherein the cyber-physical feedback loop is configured to make adjustments to operator setpoints, control action, and sensed data responsive to attacks on settings, controls, and the sensed data, respectively.

14. A method of operating an automated response controller network, the method comprising:
performing, with a first portion of a plurality of communication endpoints including a plurality of information technology devices and a plurality of operational technology devices, device control for the plurality of operational technology devices responsive to a detected threat, the first portion of the plurality of communication endpoints operating as a bottom tier of a distributed hierarchy of the plurality of communication endpoints; and
performing, with one or more other portions of the plurality of communication endpoints, network control of the automated response controller network responsive to the detected threat, the one or more other portions of the plurality of communication endpoints operating as one or more higher tiers of the distributed hierarchy.

15. The method of claim 14, wherein performing the device control comprises performing local remedial action responsive to a determination that a communication endpoint of the plurality of communication endpoints is compromised.

16. The method of claim 14, further comprising detecting a threat responsive to observed network traffic that deviates from expected network traffic.

17. The method of claim 14, wherein performing the network control comprises applying perimeter protection and traffic controls.

18. The method of claim 17, wherein applying the perimeter protection comprises applying a firewall.

19. A power control system, comprising:
a plurality of operational technology devices including power generation devices, substation devices, and loads; and
a plurality of information technology devices, the plurality of information technology devices and the plurality of operational technology devices comprising a plurality of communication endpoints organized to operate in a distributed hierarchy including:
a distributed defense tier of the distributed hierarchy, the distributed defense tier including a first portion of the plurality of communication endpoints, the first portion of the plurality of communication endpoints configured to perform device controls for the plurality of operational technology devices responsive to a detected threat;
an intermediate defense tier of the distributed hierarchy, the intermediate defense tier including a second portion of the plurality of communication endpoints; and
a centralized orchestration tier of the distributed hierarchy, the centralized orchestration tier including a third portion of the plurality of communication endpoints, the intermediate defense tier and the centralized orchestration tier configured to perform network controls responsive to the detected threat.

20. The power control system of claim 19, wherein each of the plurality of communication endpoints is configured to continue operation even if operation of one or more other communication endpoints is lost.
